(19) United States
(12) Patent Application Publication
(10) Pub. No.: US 2003/0200688 A1
(43) Pub. Date: Oct. 30, 2003

(54) Merchandising system

(76) Inventor: Gary Michael Richter, Waukesha, WI (US)

Correspondence Address: Kenneth G. Lemke, Foley & Lardner, Suite 3800, 777 East Wisconsin Avenue, Milwaukee, WI, 53202-5306, US

(21) Appl. No.: 10/367,122

(22) Filed: Feb. 14, 2003

Related U.S. Application Data
(60) Provisional application No. 60/356,896, filed on Feb. 14, 2002.

(51) Int. Cl. G09F 3/20; G09F 3/18

(52) U.S. Cl. 40/649; 40/654.01

(57) ABSTRACT

A merchandising system for product and configured to present information on an information containing article comprises a base having a front end and configured to support the product, a first panel coupled to the front end of the base, and a first retainer configured to receive the information containing article.

### CROSS-REFERENCE TO RELATED PATENT APPLICATIONS

The present application claims the benefit of priority as may be available under 35 U.S.C. §§119-21 from the following application: U.S. Patent Application No. 60/356,896 (“DISPLAY FOR MERCHANDISING SYSTEM”) filed Feb. 14, 2002 (incorporated by reference herein).

### FIELD

The present invention relates to merchandising systems. The present invention more specifically relates to a merchandising system or device configured to present or display information or indicia such as product information. The present invention also relates to an information display that may be configured for use with a merchandising system, divider system, shelf system, display system, etc. or other suitable applications.

### BACKGROUND

Merchandising systems such as product dividers, pusher trays, etc. may be used for displaying products in consumer settings such as grocery stores, retail outlets, shops, etc. Information relating to those products is commonly displayed on or near the products (or otherwise at the merchandising system). Such information may include pricing information, universal product code (UPC) information, product source information, nutritional information, size or quantity information, etc. It is known to provide a merchandising system to display such information on or near the merchandising system. According to known or conventional arrangements, the information may be provided on a label that is affixed to the merchandising system using adhesives. When products are moved, restocked, reconfigured, etc., the information (e.g. label) must be moved or changed in order to accompany the product. Alternatively, when product information is updated, the label may also need to be updated. However, use of adhesives may require the label to be peeled off of the merchandising system in order to move or change the label. This may damage the label, leave parts of the label still attached to the merchandising system, leave visually unappealing effects, etc.

According to other known or conventional arrangements, an information label may be provided in a slot along a bottom of a shelf such that a label is received in the slot. However, this arrangement may allow the label to move along the length of the slot, and along the length of the shelf. This may result in labels being provided near products to which the labels do not relate.

Accordingly, it would be advantageous to provide a system that is intended to provide for the display of information and information containing articles including various indicia. It would further be advantageous to provide a system that may be provided to present information along a front or facing edge or other section or surface of a merchandising system. It would further be advantageous to provide a system that may be attached, coupled to, or configured to be provided with a variety of merchandising systems, such as pusher tray systems. It would further be advantageous to provide a system that would provide for the secure retention of an information containing article, such as a label, with respect to the product to which it relates. It would further be advantageous to provide a system that is configured to allow for changing, updating, placement, replacement, etc. of information containing articles (such as labels) with relative ease and/or convenience, for example without the need for adhesives or other permanent bond attachments. It would further be advantageous to provide a system that is intended to provide for the prominent and convenient display of universal product codes (UPCs), bar codes, and pricing information, and that may be updated relatively quickly and easily. It would further be advantageous to provide a system that is configured to allow the use of nonpermanent attachments or low bond adhesives to display information, indicia, and information containing articles, for example on a merchandising system without the use of permanent or high bond adhesives or other permanent bond attachments. It would further be advantageous to provide a system that may be configured to display or present information containing articles, such as cards, placard, labels, etc., and to allow for the display and presentation of information about a product in a merchandising system.

It would be advantageous to provide a system for the display of information in association with a merchandising system or the like that includes any one or more of these or other advantageous features.

### SUMMARY

The present invention relates to a merchandising system for product and configured to present information on an information containing article. The merchandising system comprises a base having a front end and configured to support the product, a first panel coupled to the front end of the base, and a first retainer configured to receive the information containing article.

The present invention further relates to a front panel for a merchandising system, the front panel for displaying information provided on a label. The front panel includes a base coupled to the merchandising system, a retainer coupled to an outward facing side of the base. The label is held in place by the retainer.

The present invention further relates to a merchandising system to display and store products having a base to support the products and a front panel provided on an end of the base, and for presenting information on a label related to the products provided on the base. The improvement comprises a retainer coupled to the front panel to receive the label. The retainer allows for the selective placement and removal of the label without an adhesive fastener.

The present invention further relates to a merchandising system for product and configured to present information on an information containing article. The merchandising system comprises a base having a front end and configured to support the product, a first panel coupled to the front end of the base, and a second panel provided adjacent to the first panel. The information containing article is received between the first panel and the second panel.

### BRIEF DESCRIPTION OF THE DRAWINGS

FIG. 1 is a perspective view of a merchandising system according to an exemplary embodiment.

FIG. 2 is an exploded perspective view of the merchandising system shown in FIG. 1.

FIG. 3 is a perspective view of a merchandising system according to an exemplary embodiment.

FIG. 4 is a rear perspective view of the front panel shown in FIG. 1.

FIG. 5 is an exploded perspective view of a front panel according to an exemplary embodiment.

FIG. 5A is a side view of the front panel shown in FIG. 1.

FIG. 6 is a perspective view of a front panel for use with a merchandising system according to an alternative embodiment.

FIG. 7 is a perspective view of a front panel for use with a merchandising system according to an alternative embodiment.

FIG. 8 is a perspective view of a front panel for use with a merchandising system according to an alternative embodiment.

FIG. 9 is a perspective view of a front panel for use with a merchandising system according to an alternative embodiment.

FIG. 10 is a perspective view of a front panel for use with a merchandising system according to an alternative embodiment.

FIG. 10A is a side elevation view of the front panel shown in FIG. 10.

FIG. 11 is a perspective view of a front panel for use with a merchandising system according to an alternative embodiment.

FIG. 11A is a side elevation view of the front panel shown in FIG. 11.

FIG. 12 is a perspective view of a front panel for use with a merchandising system according to an alternative embodiment.

FIG. 12A is a side elevation view of the front panel shown in FIG. 12.

FIG. 13 is a perspective view of a front panel for use with a merchandising system according to an alternative embodiment.

FIG. 13A is a side elevation view of the front panel shown in FIG. 13.

FIGS. 14 and 15 are perspective views of various front panels for use with a merchandising system according to alternative embodiments.

FIG. 16 is a perspective view of a front panel for use with a merchandising system according to alternative embodiments.

FIG. 16A is a top plan view of the front panel shown in FIG. 13.

FIG. 17 is a perspective view of a front panel for use with a merchandising system according to an alternative embodiment.

FIG. 18 is a front elevation view of the front panel shown in FIG. 17.

FIG. 19 is a cross section view along the line 19-19 shown in FIG. 18.

FIG. 20 is a perspective view of a retainer for use with a merchandising system according to an alternative embodiment.

FIG. 20A is a side elevation view of the retainer shown in FIG. 20.

### DETAILED DESCRIPTION OF EXEMPLARY EMBODIMENTS

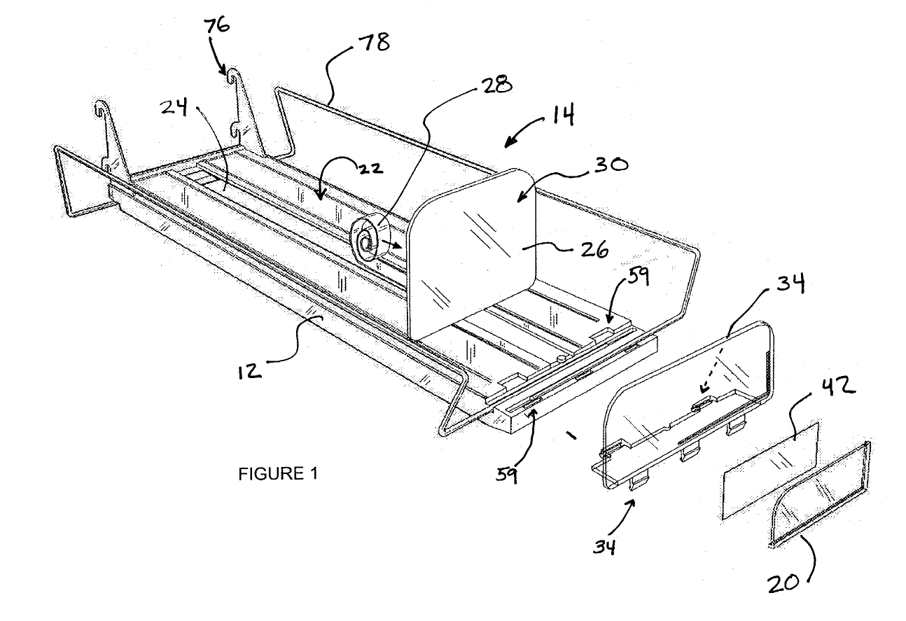

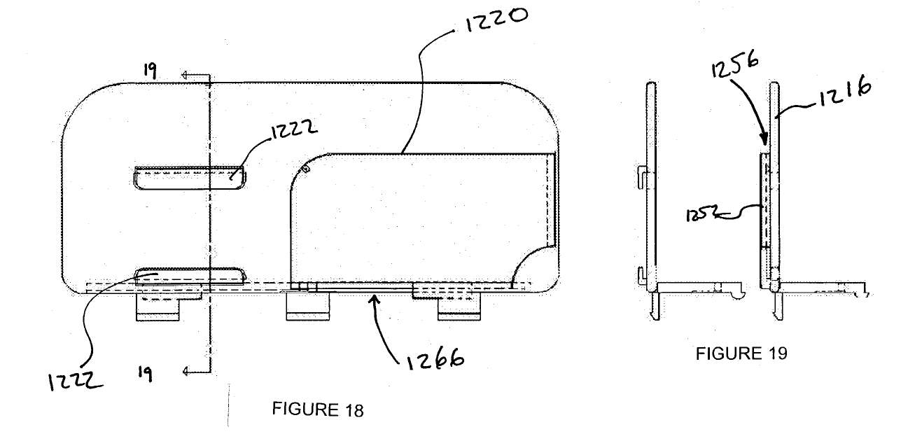

Referring to FIGS. 1-20A, various exemplary and alternative embodiments of a merchandising system are shown.

Merchandising systems such as product dividers, pusher trays, self-facing merchandising systems, shelves, racks, displays, etc. are used for displaying products in consumer settings such as grocery stores, retail outlets, shops, etc. Merchandising systems may be used to dispense, store, merchandise, display, etc. products, including food products. Information relating to those products may be displayed on or near the products.

Using the various embodiments disclosed, product information may be provided by placing an information containing article (e.g., label, card, etc.) in a retainer or holder or other support provided on the merchandising system, as opposed to affixing the label to the merchandising system directly with adhesives, etc. This has the advantage of allowing relatively easy changing or updating of the label. When products are moved, restocked, reconfigured, etc., the label may need to be moved or changed in order to accompany the product. Using the various embodiments, a label may be easily inserted into, and removed from the merchandising system without requiring the label to be peeled off or otherwise removed. The label is kept securely in one position, while still allowing the label to be easily inserted and removed.

The various exemplary embodiments are intended to provide for easy stocking of product by allowing identification of product information on a front or facing edge of the merchandising system. The various exemplary embodiments further provide for inventory control, inventory management, taking inventory, etc. by providing product information on a front or facing edge of the merchandising system to be readily visible by a human eye, scanning device, etc. The various exemplary embodiments further provide customers with information located near the product, enhanced visibility of product information, easy access to the product information, easy placement, interchangeability, removal and replacement of product information, etc. Additionally, various exemplary embodiments are intended to allow for the scanning of information (e.g. UPC label) by various devices such as bar code scanning devices.

Information, including indicia, cards, labels, etc. may be easily provided with the merchandising system by inserting an information containing article into a retainer. Should the information need to be changed, removed, updated, replaced, etc., the information containing article may be easily removed from the retainer.

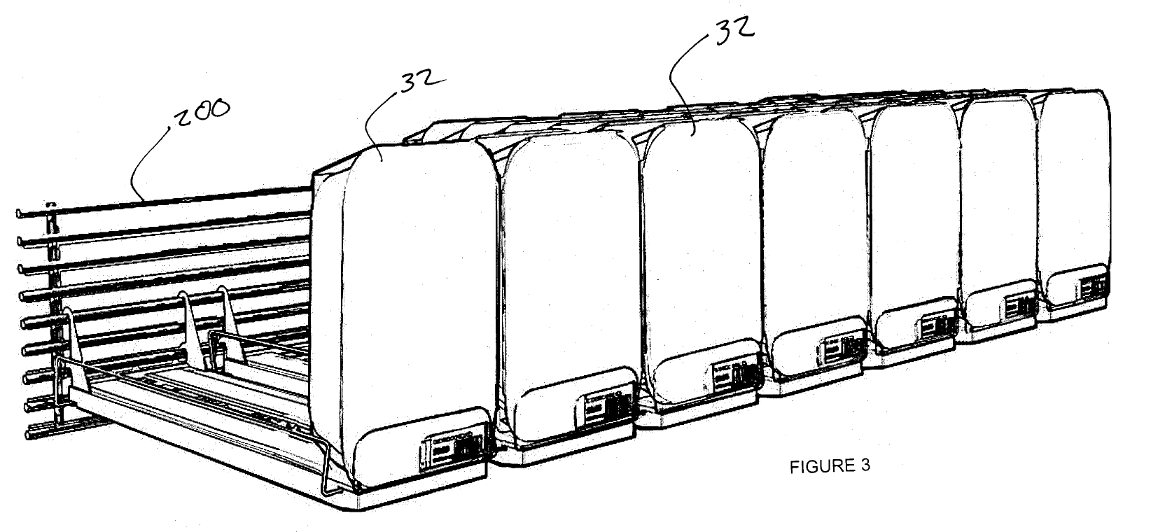

Shown in FIG. 1 is a merchandising system 10 according to an exemplary embodiment. Merchandising system 10 is configured to store and display products, such as food products, in grocery stores, shops, etc. Merchandising system 10 may be referred to as a self-facing merchandising system or a pusher tray system. According to a particularly preferred embodiment, several merchandising systems may be attached or otherwise provided on a support structure (such as a wire grid 200 shown in FIG. 3) with hooks 76 to form an area to display like products (such as food products of a same type, producer, etc.). Merchandising system 10 may also comprise side members 78 to further retain product in a side-to-side orientation. According to a particularly preferred embodiment, side members 78 are adjustable to accommodate differently sized products. Merchandising systems 10 may have a similar arrangement or constructions as those disclosed in U.S. Pat. No. 5,855,283 (“PRODUCT DISPLAY”) incorporated by reference herein), or U.S. Pat. No. 5,855,281 (“PRODUCT DISPLAY SYSTEM”) (incorporated by reference herein), or a wide variety of other configurations.

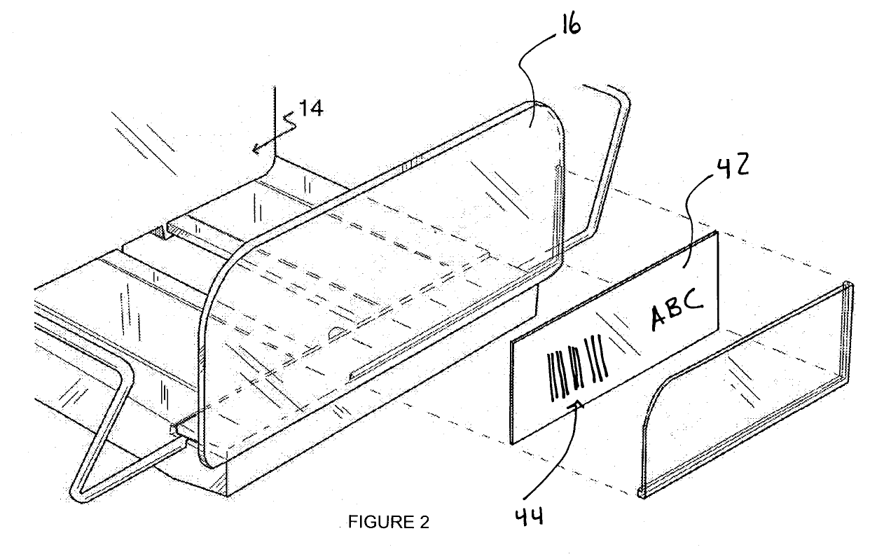

As shown in FIGS. 1 and 2, merchandising system 10 comprises a base 12, a pusher assembly 14, a first panel 16, and a retainer 20.

Base 12 is configured to support products which are placed on an upper surface 22 of base 12. Base 12 comprises a slot 24 provided along a substantial length of base 12. Slot 24 is configured to receive pusher assembly 14. Pusher assembly 14 is configured to move in a direction parallel to slot 24 along the length of base 12. Pusher assembly 14 comprises pusher 26 and a biasing element 28. Pusher 26 includes a face 30 which will coact or press against product 32 provided on base 12 (FIG. 3). Pusher 26 is configured to be biased, pushed or forced toward the front of base 12 by biasing element 28. According to a particularly preferred embodiment, biasing element 28 is a coil spring. According to alternative embodiments, the biasing element may be a variety of structures which provide a forward biasing force on the pusher, such as springs, elastomeric material, etc.

First panel 16 is coupled to base 12 near a front of base 12. First panel 16 is configured to retain (or otherwise restrain) product 32 from moving beyond the front of base 12. This configuration is known as a “selffacing” tray or merchandiser. When a product 32 is removed from merchandising system 10, pusher assembly 14 moves or urges the remaining product toward the front of merchandising system 10, creating a neat, fully stocked appearance.

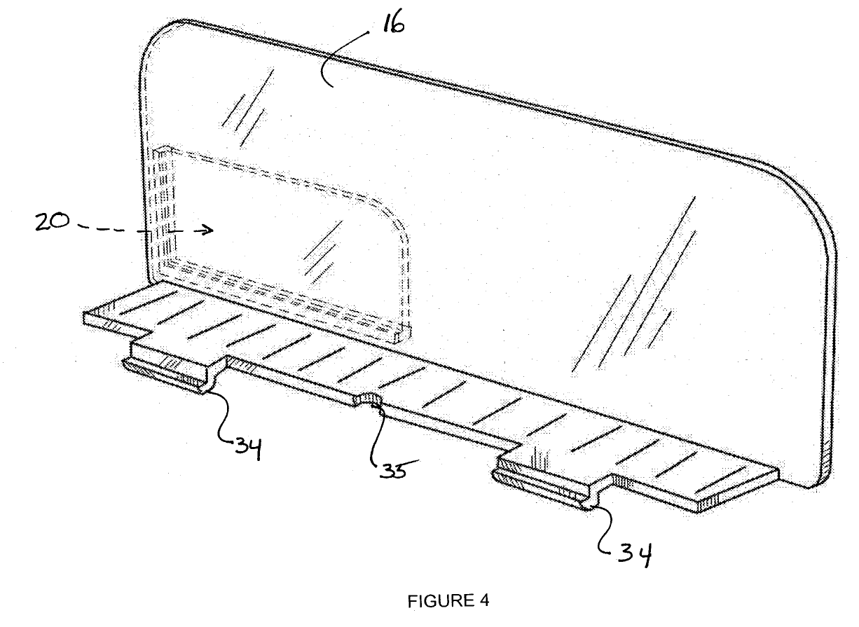

According to a particularly preferred embodiment shown in FIG. 1, first panel 16 is provided as a front panel, plate or front lens on merchandising system 10. First panel 16 may be attached to a front edge of the pusher tray system. First panel 16 is configured to restrain product 32 and resist the biasing force of pusher assembly 14. First panel 16 may be coupled or attached along the front edge of base 12 using a variety of interfaces. As shown in FIG. 4, first panel 16 comprises an interface shown as a plurality of fingers or extensions 34. Fingers 34 couple or attach to both a top and bottom side of base 12. Fingers 34 couple or interact with apertures or depressions 59 provided in base 12. According to alternative embodiments, other interfaces such as adhesives, mechanical fasteners, etc. may be used, or the first panel may be integrated directly with the base. First panel 16 may also comprise a notch or a cutout 35 which allows a rivet of other fastener, connecting biasing member 28 to base 12, to not interfere with the first panel 16.

As shown in FIG. 1, merchandising system 10 further comprises retainer 20. Retainer 20 may comprise a pocket, window, lens, display, holder, recess, frame, wall, channel, slot, clip, panel, etc. According to a particularly preferred embodiment, retainer 20 is coupled to first panel 16. Retainer 20 is configured to receive information, indicia or an information containing article (such as a label, card, etc.). According to a particularly preferred embodiment, the holder is configured to receive a universal product code (UPC) label, product pricing information, barcode label, etc.

According to various exemplary embodiments shown in the FIGURES, the retainer may have various shapes, configurations, constructions, and assemblies to receive and display the information, indicia or information containing article.

As shown in FIG. 1, retainer 20 may be provided on a front or outer surface of first panel 16. Retainer 20 may provide the shape or construction of a slot or window in which a label 42 (such as a card, placard, information or indicia may be received (see FIG. 1). Information such as text, graphics, barcode information, etc. (shown as indicia 44) may be provided on label 42. Label 42 may be relatively easily inserted and removed. Furthermore, label 42 will be prominently displayed in front of merchandising system 10 and will be associated with product 32 provided on merchandising system 10.

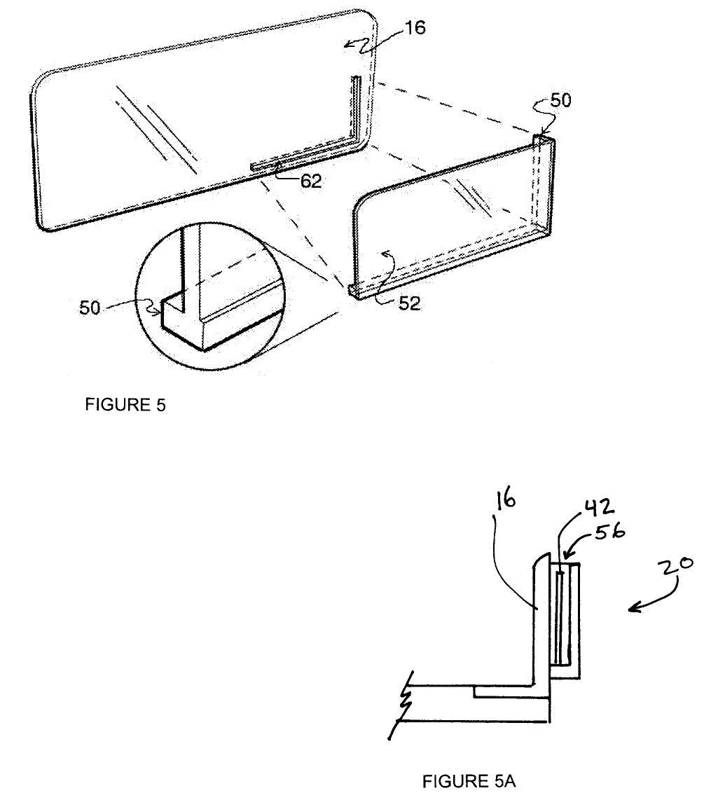

As shown in FIG. 5, retainer 20 comprises a frame portion 50 and a panel portion 52. Frame portion 50 may be a “horn” or raised surface or other segment of material configured to couple or connect with first panel 16. According to a particularly preferred embodiment, frame portion 50 includes a portion of material that bonds, melts, or otherwise adheres to first panel 16 in a sonic welding process. Panel portion 52 is coupled to, connected to, or integrally formed with frame portion 50. According to a particularly preferred embodiment, panel portion 52 is a single panel coupled to frame portion 50. Accordingly, a gap 56 (or recess, slot, etc.) is formed between panel portion 52 and first panel 16 (i.e., the front lens). Label 42 may be received in gap 56 (see FIG. 5 side-section view).

As shown in FIG. 5, first panel 16 includes a recess 62 having a similar shape as frame portion 50. Recess 62 may be used to align or ensure proper placement of retainer 20 relative to first panel 16. Frame portion 50 fits into recess 62 and then may be attached to first panel 16 by sonic welding, adhesives, etc. According to an exemplary embodiment, panels 16 and 52 are constructed from a substantially transparent material.

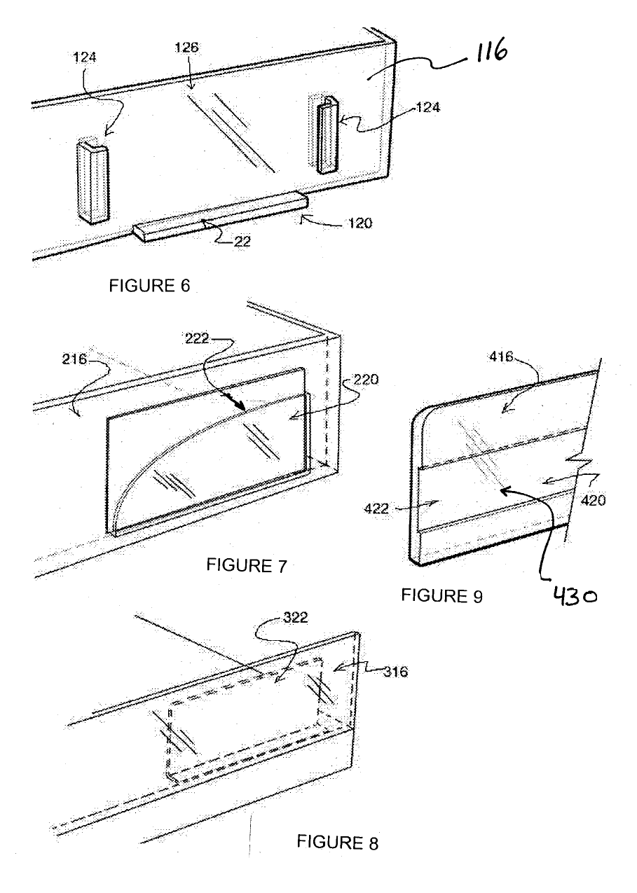

According to an alternative embodiment shown in FIG. 6, a retainer 120 may be provided on a front or outer surface of first panel 116. Retainer 120 may have a ledge 122 (or surface, protrusion, support or extension) on which a label is supported. Retainer 120 may further comprise one or more retaining elements 124 provided on one or more sides of the label. Retaining elements 124 may have an L-shape or a C-shape cross-section. Retaining element 124 may be an angled element (such as a 90 degree, L-shape, clip, etc.) protruding from first panel 116 which assists to retain the label. The label may be inserted from an opening 126 on the top of retainer 120, retained by the one or more retaining elements 124, and supported by ledge 122.

According to an alternative embodiment shown in shown in FIG. 7, a retainer 220 may be provided on a front or outer surface of first panel 216. Retainer 220 may have a construction similar to retainer 20 shown in FIG. 1, but may comprise an angled or curved portion 222.

As shown in FIG. 8, a retainer 320 may comprise a panel 322 provided on a back side (or inner surface) of first panel 316. A label is received between panel 322 and panel 316.

As shown in FIG. 9, retainer 420 may be a slot 422 (or recess, channel, etc.) provided in first panel 416. A label may be provided in retainer 420 by sliding the label into the retainer via an end of slot 422, or by slightly deforming the label to fit into an open face 430 of slot 422.

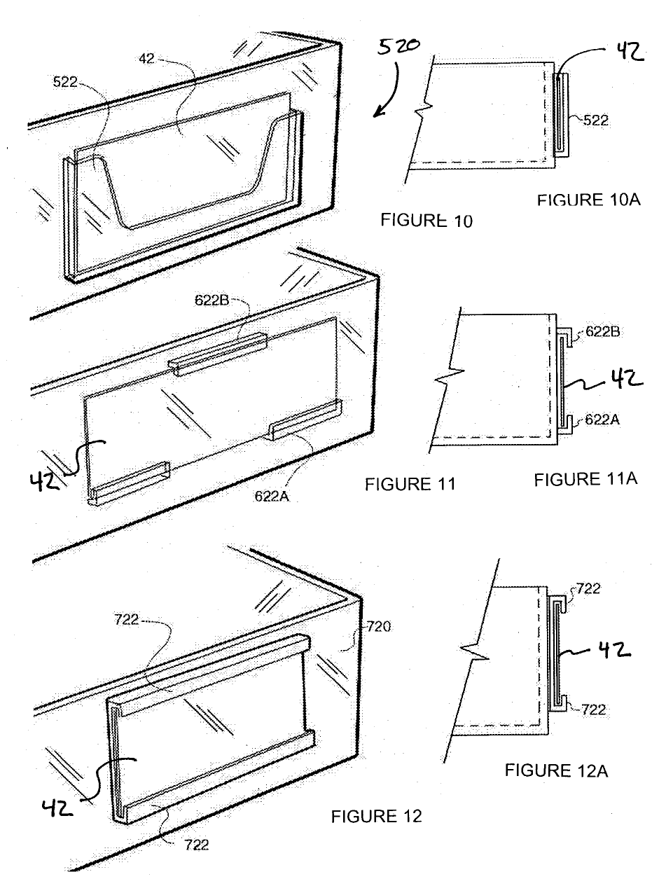

As shown in FIG. 10, retainer 520 may be a frame 522 which has an open top to receive label 42. According to a particularly preferred embodiment, retainer 520 is a separate frame which is attached to first panel 16 with adhesives, etc.

As shown in FIG. 11, retainer 620 may be one or more channels 622. According to a particularly preferred embodiment, two “L-shaped” channels 622a are provided along a lower edge of retainer 620, and one “L-shaped” channel 622b is provided along an upper edge of retainer 620. According to various alternative embodiments, the number and orientation and configuration of the channels may be varied. As shown in FIG. 12, retainer 720 may comprise two “C-shaped” channels 722, with one channel 722 configured to be provided along an upper edge of a label and a second channel 722 configured to be provided along a lower edge of the label. The channels may be co-molded or otherwise integrally formed with the base. Alternatively, the channels may be attached to the base using other fasteners, including adhesives, sonic welding, etc.

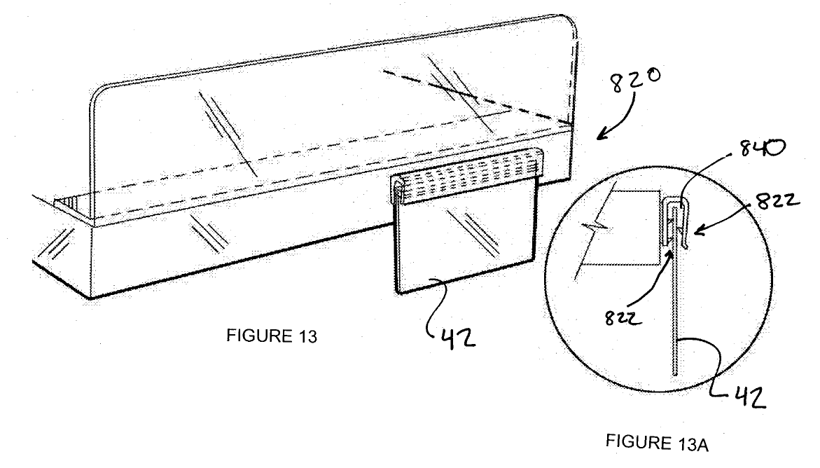

As shown in FIG. 13, retainer 820 may be a clip. According to a particularly preferred embodiment, retainer 820 has flexible fingers 822 which flex as label 42 is inserted into retainer 820 (and into space 840) and hold label 42 in place. Fingers 822 (or extensions) may be constructed or assembled from a soft, semi-rigid, or compliant material. According to alternative embodiments, retainer may be a spring biased, or spring loaded clip that clamps to the label. According to an alternative embodiment, the fingers may be a rigid material.

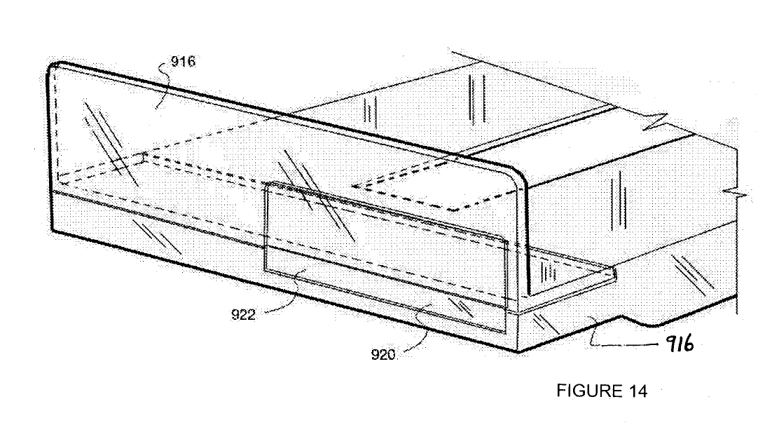

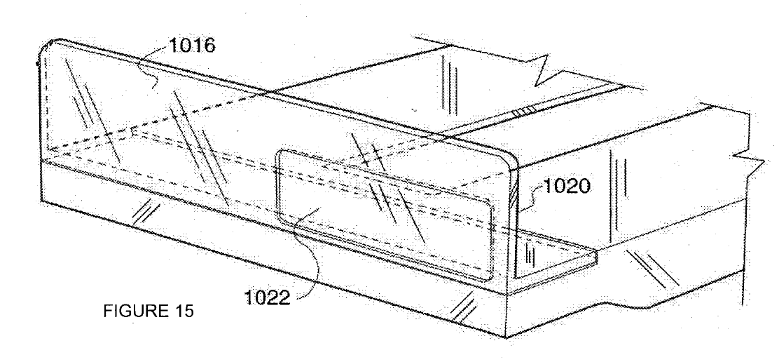

As shown in FIG. 14, retainer 920 may comprise a recessed area 922 provided in first panel 916 and base 912. As shown in FIG. 15, retainer 1020 may comprise a recessed area 1022 provided in first panel 1016. A label may be affixed or attached to the recessed area with a low bond or low tack adhesive. The recess may be provided on a front surface or a back surface of the first panel. By providing the recess on the front of the base provides for easier access to the information containing article, and thereby easier updating, replacement, etc.

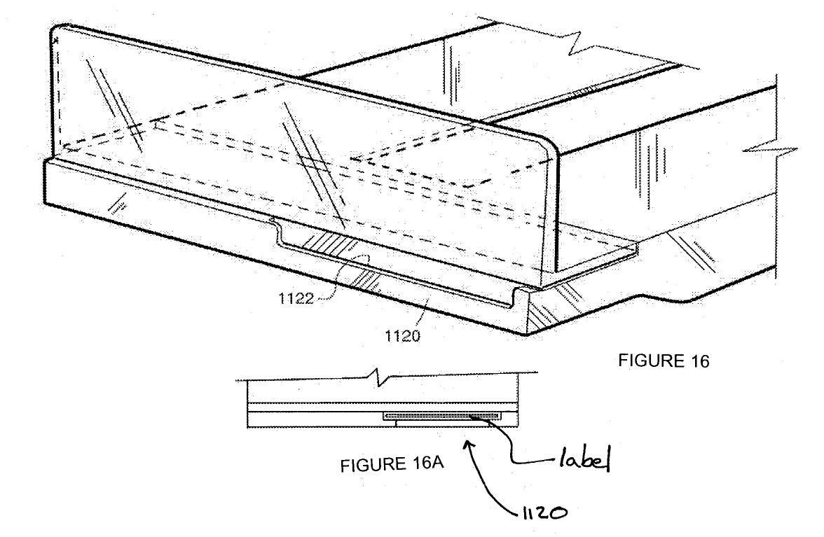

As shown in FIG. 16, retainer 1120 may be a pocket 1122 provided in base 1112. In a particularly preferred embodiment, pocket 1122 is molded into a front edge of base 1112. Pocket 1122 is configured to retain a label along a lower portion or edge.

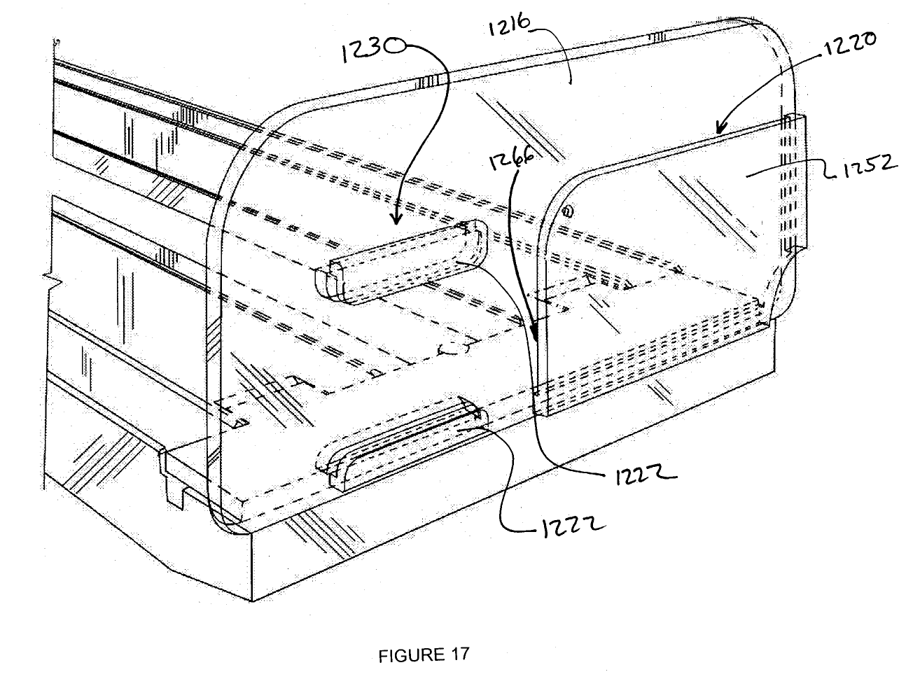

As shown in FIG. 17, a first retainer 1220 and a second retainer 1230 may be provided on a front or outer surface of first panel 1216. First retainer 1220 may have a similar arrangement or construction as retainer 20. A gap 1256 (or recess, slot, etc.) is formed between a panel portion 1252 and first panel 1216 (i.e., the front lens) (see FIG. 19). A label may be received in gap 1256 and supported and retained by panel portion 1252 and along a bottom or lower edge 1266. Second retainer 1230 may have a similar arrangement or construction as retainer 720. Second retainer 1230 comprises two “C-shaped” channels 1222, with one channel 1222 configured to be provided along an upper edge of a label and a second channel 1222 configured to be provided along a lower edge of the label. The channels may be co-molded, integrally formed, or otherwise attached with first panel 1216. According to a particularly preferred embodiment, first retainer 1220 may be used to display or present a first label (such as a UPC label) and second retainer 1230 may be used to display or present a second label (such as a pricing label).

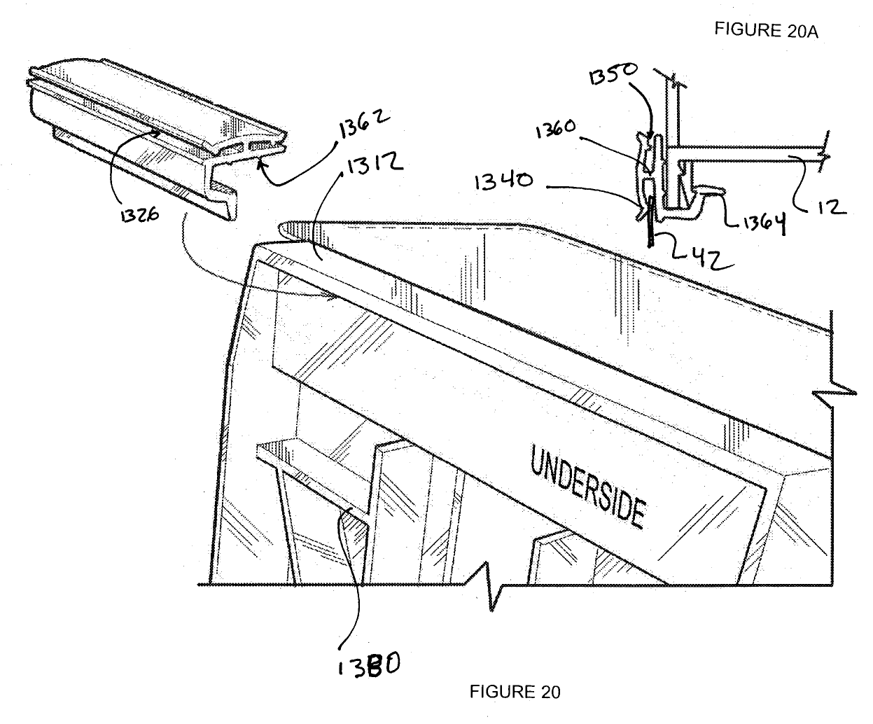

As shown in FIG. 20, a retainer 1320 may be coupled to a lower portion of base 1312. Retainer 1320 may comprise one or more slots 1326 to receive a label, and one or more flexible fingers which flex to allow the label to be inserted into slot 1326 and then retain the label. According to an alternative embodiment, arm portion 1340 of retainer 1320 may provide a retaining force to the label. A projection 1350 may be provided to assist in retaining a label. Arm portion 1340 is connect to retainer 1320 by web 1360. According to a particularly preferred embodiment, retainer 1320 is configured to clip or snap fit into a bottom portion of base 1312. Retainer 1320 may be held is place with respect to base 12 by arm 1364 fitting around a portion of base 12 and pressing protrusions 1362 against base 12. Base 12 may comprise one or more reinforcing members 1380 to rigidify or strengthen base 12.

According to various exemplary embodiments shown in the FIGURES, a wide variety of materials may be used in construction and assembly of the display. For example, a wide variety of plastics, including moldable plastic, high impact plastic, etc. may be used. Alternatively, metals, alloys, polymers, composites, etc. may also be used. According to a particularly preferred embodiment, the display system may include a portion constructed from a transparent material such that the information containing article may be viewed. It should be understood that not all embodiments of the display system will require transparent material. The display systems may be assembled and constructed from various methods including injection molding, extrusion, casting, sonic welding, adhesion, etc.

It is important to note that the construction and arrangement of the elements of the system as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability, in any of a wide variety of colors, textures and combinations. It should also be noted that the system may be used in association with adjustable, or fixed and non-movable systems or any of a wide variety of other merchandising systems in any of a wide variety of other applications. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

What is claimed is:

1. A merchandising system for product and configured to present information on an information containing article comprising:
a base having a front end and configured to support the product;
a first panel coupled to the front end of the base; and
a first retainer configured to receive the information containing article.

2. The merchandising system claim 1 wherein the first retainer comprises a second panel.

3. The merchandising system of claim 2 wherein the information containing article is received between the first panel and the second panel.

4. The merchandising system of claim 3 further comprising a second retainer provided on the first panel.

5. The merchandising system of claim 4 wherein the second retainer comprises an upper channel and a lower channel.

6. The merchandising system claim 2 wherein the second panel comprises a transparent material.

7. The merchandising system claim 6 wherein the first panel comprises a transparent material.

8. The merchandising system claim 1 wherein the first retainer comprises at least one of a ledge, a recess, a slot, at least two opposing L-channels, at least two opposing C-channels, a flexible member, a recessed portion provided in the first panel, a pocket, and a pocket integrally formed in the base.

9. The merchandising system claim 1 wherein the first retainer comprises a depression provided in the first panel.

10. The merchandising system claim 9 wherein the depression is provided in at least one of a front side or a back side of the first panel.

11. The merchandising system claim 1 wherein the first retainer is configured to receive a universal product code.

12. The merchandising system claim 1 wherein the first retainer is configured to receive at least one of a label and a card.

13. The merchandising system claim 1 further comprising a pusher assembly configured to move the product toward the front of the base.

14. The merchandising system claim 13 wherein the pusher assembly further comprises a pusher face and a biasing element.

15. The merchandising system of claim 1 further comprising an information containing article received in the retainer.

16. The merchandising system of claim 15 wherein the information containing article comprises at least one of a label, a card, a sheet, a universal product code (UPC), a barcode, and a price label.

17. A front panel for a merchandising system, the front panel for displaying information provided on a label, the front panel comprising:
a base coupled to the merchandising system;
a retainer coupled to an outward facing side of the base, wherein the label is held in place by the retainer.

18. The front panel of claim 17 wherein the retainer comprises a first panel provided on the base, and wherein the label is received between the base and the first panel.

19. The front panel of claim 18 wherein the first panel comprises a transparent material

20. A merchandising system to display and store products having a base to support the products and a front panel provided on an end of the base, and for presenting information on a label related to the products provided on the base, wherein the improvement comprises:
a retainer coupled to the front panel to receive the label;
wherein the retainer allows for the selective placement and removal of the label without an adhesive fastener.

21. The merchandising system of claim 20 wherein the retainer comprises a window that allows the label to be viewed through the window.

22. The merchandising system of claim 20 wherein the retainer is provided on a back side of the front panel.

23. The merchandising system of claim 20 wherein the retainer is provided on a front side of the front panel.

24. The merchandising system of claim 17 wherein further comprising a second retainer that allows for the selective placement and removal of a second label without an adhesive fastener.

25. A merchandising system for product and configured to present information on an information containing article comprising:
a base having a front end and configured to support the product;
a first panel coupled to the front end of the base; and
a second panel provided adjacent to the first panel;
wherein the information containing article is received between the first panel and the second panel.
